(19) United States
(12) Patent Application Publication
(10) Pub. No.: US 2026/0370991 A1
(43) Pub. Date: Nov. 19, 2026

(54) CONTROL APPARATUS AND CONTROL METHOD

(71) Applicant: NTT, Inc., Tokyo (JP)

(72) Inventors: Hirotaka UJIKAWA, Musashino-shi (JP); Yoshihito SAKAI, Musashino-shi (JP); Tatsuya SHIMADA, Musashino-shi (JP)

(73) Assignee: NTT, Inc., Tokyo (JP)

(21) Appl. No.: 19/137,579

(22) PCT Filed: Dec. 13, 2022
(86) PCT No.: PCT/JP2022/045869

§ 371 Date: Jun. 10, 2025

(51) Int. Cl. H04Q 11/00; H04W 72/0446; H04W 88/08

(52) U.S. Cl. CPC H04Q 11/0067; H04Q 11/0005; H04W 72/0446; H04Q 2011/0033; H04Q 2011/0086; H04Q 2213/13164; H04W 88/085

(57) ABSTRACT

Provided is a control device connected to a master station device via a network in a mobile communication system in which the master station device is connected to a user terminal via a slave station device, the control device including: an information analysis unit configured to acquire information on a control message that is transmitted from the master station device to the user terminal connected to the slave station device and that grants periodic transmission permission, and calculate, on the basis of the acquired control message, a time at which upstream traffic from the user terminal will arrive at a network device that is provided between the master station device and a host device or that includes an own device, during a control target period that is longer than the shortest period of the periodic transmission permission; and a control content determination unit configured to determine control content for controlling an operation of the network device on the basis of the calculated time and transmit the determined control content to the network device.

### TECHNICAL FIELD

The present invention relates to a control device and a control method.

### BACKGROUND ART

In a case where an optical transmission device is applied to a mobile fronthaul (MFH) of a conventional mobile system, scheduling of uplink communication in an optical transmission section is performed by cooperative dynamic bandwidth allocation (cooperative DBA: CO-DBA). In contrast, in 5th generation new radio (5G-NR), the length of a slot, which is the basic unit of scheduling, changes depending on a subcarrier spacing. For example, in a case where the subcarrier spacing is 15 kHz, the slot length is 1 ms, whereas in a case where the subcarrier spacing is widened to 120 kHz, the slot length is shortened to 125 μs. In this way, when higher frequencies are used to widen the system bandwidth (for example, to achieve high throughput), the subcarrier spacing becomes wider, and the slot width becomes shorter in time accordingly.

### CITATION LIST

### Non Patent Literature

[NPL 1] Kazuki Takeda and 5 others, “NR Physical Layer Specifications for 5G”, [online], NTT DOCOMO Technical Journal, Vol. 26, No. 3.

[NPL 2] “SERIES G: TRANSMISSION SYSTEMS AND MEDIA, DIGITAL SYSTEMS AND NETWORKS”, ITU-T, ITU-T G-series Recommendations-Supplement 71 (OLT capabilities for CO-DBA).

[NPL 3] “5G/NR-Configured Scheduling”, Share Technote, [Retrieved on Dec. 5, 2022], Internet <URL: https://www.sharetechnote.com/html/5G/5G_ConfiguredScheduling.html>

### SUMMARY OF INVENTION

### Technical Problem

As described above, in a method of receiving a cooperative frame for each scheduling unit, such as in the conventional cooperative DBA, there are cases where the amount of processing increases and the processing cannot be handled. In addition, 5G has a mechanism called semi-persistent scheduling, which makes it possible to perform uplink transmission at short periods without transmitting an uplink grant. However, if a control frame is transmitted from a wireless communication system to a controller for each short-period allocation, the processing load on the wireless communication system and the controller increases significantly. As described above, conventional wireless communication systems have a problem in that the processing load increases because processing is performed for each scheduling unit.

In view of the above circumstances, an object of the present invention is to provide a technique capable of reducing the processing load.

### Solution to Problem

According to an aspect of the present invention, there is provided a control device connected to a master station device via a network in a mobile communication system in which the master station device is connected to a user terminal via a slave station device, the control device including: an information analysis unit configured to acquire information on a control message that is transmitted from the master station device to the user terminal connected to the slave station device and that grants periodic transmission permission, and calculate, on the basis of the acquired control message, a time at which upstream traffic from the user terminal will arrive at a network device that is provided between the master station device and a host device or that includes an own device, during a control target period that is longer than the shortest period of the periodic transmission permission; and a control content determination unit configured to determine control content for controlling an operation of the network device on the basis of the calculated time and transmit the determined control content to the network device.

According to another aspect of the present invention, there is provided a control method performed by a control device connected to a master station device via a network in a mobile communication system in which the master station device is connected to a user terminal via a slave station device, the control method including: acquiring information on a control message that is transmitted from the master station device to the user terminal connected to the slave station device and that grants periodic transmission permission; calculating, on the basis of the acquired control message, a time at which upstream traffic from the user terminal will arrive at a network device that is provided between the master station device and a host device or that includes an own device, during a control target period that is longer than the shortest period of the periodic transmission permission; determining control content for controlling an operation of the network device on the basis of the calculated time; and transmitting the determined control content to the network device.

### Advantageous Effects of Invention

The present invention makes it possible to reduce the processing load.

### BRIEF DESCRIPTION OF DRAWINGS

FIG. 1 A diagram for describing an overview of the present invention.

FIG. 2 A diagram illustrating an example of a configuration of a wireless communication system according to a first embodiment.

FIG. 3 A diagram for describing an overview of a process performed by a control device according to the first embodiment.

FIG. 4 A flowchart showing a process flow of the control device according to the first embodiment.

FIG. 5 A diagram illustrating an example of a configuration of a wireless communication system according to a second embodiment.

FIG. 6 A diagram for describing an overview of a process performed by a control device according to the second embodiment.

### DESCRIPTION OF EMBODIMENTS

Embodiments of the present invention will be described below with reference to the drawings.

### Overview

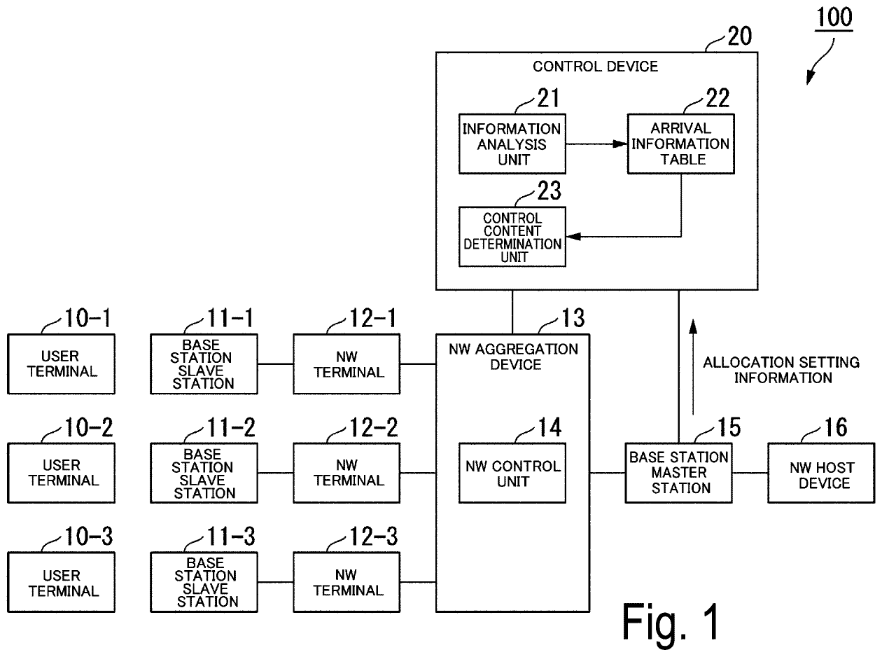

FIG. 1 is a diagram for describing an overview of the present invention. A wireless communication system 100 illustrated in FIG. 1 includes a plurality of user terminals 10 (for example, user terminals 10-1 to 10-3), a plurality of base station slave stations 11 (for example, base station slave stations 11-1 to 11-3), a plurality of NW terminals 12 (for example, NW terminals 12-1 to 12-3), a NW aggregation device 13, a base station master station 15, a NW host device 16, and a control device 20. FIG. 1 illustrates a configuration in which the wireless communication system 100 includes three user terminals 10, three base station slave stations 11, and three NW terminals 12, but the numbers of user terminals 10, base station slave stations 11, and NW terminals 12 are not particularly limited. The wireless communication system 100 is one aspect of a mobile communication system.

It is assumed that the user terminal 10-1 is wirelessly connected to the base station slave station 11-1, the user terminal 10-2 is wirelessly connected to the base station slave station 11-2, and the user terminal 10-3 is wirelessly connected to the base station slave station 11-3. The base station slave station 11-1 is connected to the NW terminal 12-1 by wire, the base station slave station 11-2 is connected to the NW terminal 12-2 by wire, and the base station slave station 11-3 is connected to the NW terminal 12-3 by wire. Each of the NW terminals 12-1 to 12-3 is connected to the NW aggregation device 13 by wire. The NW aggregation device 13 is connected to the base station master station 15 and the control device 20 by wire.

The user terminal 10 performs uplink transmission at a timing designated by allocation setting information that permits periodic transmission and that is transmitted from the base station master station 15. The allocation setting information that permits periodic transmission and is transmitted from the base station master station 15 includes information indicating the timing of uplink transmission and information on the volume of traffic that can be transmitted.

The base station slave station 11 transmits the allocation setting information transmitted from the base station master station 15 to the user terminal 10. The base station slave station 11 is, for example, a 5G radio unit (RU). The base station slave station 11 is one aspect of a slave station device.

The NW terminal 12 relays signals transmitted and received between the base station slave station 11 and the NW aggregation device 13. In a case where the NW aggregation device 13 is an optical line terminal (OLT) in a passive optical network (PON), the NW terminal 12 is an optical network unit (ONU).

The NW aggregation device 13 is a device that aggregates uplink transmissions sent from the user terminals 10. The NW aggregation device 13 is, for example, an OLT or an optical distribution device. The optical distribution device is, for example, an optical switch that has a plurality of first ports and a plurality of second ports, and outputs an optical signal input from one port to another port.

The NW aggregation device 13 includes a NW control unit 14. The NW control unit 14 controls the operation of the NW aggregation device 13 on the basis of an instruction transmitted from the control device 20. For example, in a case where the NW aggregation device 13 is an OLT, the NW control unit 14 performs bandwidth allocation and the like. For example, in a case where the NW aggregation device 13 is an optical distribution device, the NW control unit 14 controls the connection of the ports.

The base station master station 15 transmits, by means of a configured grant, allocation setting information that permits periodic transmission to the user terminal 10 via the base station slave station 11. Furthermore, the base station master station 15 also transmits the allocation setting information to the control device 20. The base station master station 15 is configured, for example, by a distributed unit (DU) in 5G or a combination of a DU and a centralized unit (CU). The base station master station 15 is one aspect of a master station device.

The NW host device 16 is a device located at a higher level in the network.

The control device 20 controls the operation of the NW aggregation device 13 on the basis of the allocation setting information transmitted from the base station master station 15. The control device 20 includes an information analysis unit 21, an arrival information table 22, and a control content determination unit 23.

The information analysis unit 21 calculates an arrival timing of data for a control target period of the NW aggregation device 13 on the basis of the allocation setting information transmitted from the base station master station 15 and an allocation reference time. The information analysis unit 21 may acquire the allocation reference time on the basis of dynamic allocation information from the base station master station 15, or may uniquely determine in advance, for example, that “the beginning of the most recent radio frame (in 10 ms units) is used as the reference time” and follow that rule. The information analysis unit 21 associates information on the calculated arrival timing of data with information on the traffic volume and registers them in the arrival information table 22. The information analysis unit 21 may update the information registered in the arrival information table 22 only when the periodic transmission permission is updated. This reduces the frequency of required calculations.

In the arrival information table 22, information on the arrival timing of data calculated by the information analysis unit 21 and information on the traffic volume are registered in association with each other.

The control content determination unit 23 determines control information for providing an instruction of the operation of the NW control unit 14 of the NW aggregation device 13 after a certain period of time on the basis of the arrival information table 22. Specifically, the control content determination unit 23 reads information (arrival time and volume) of traffic arriving within the control target period of the NW aggregation device 13 from the arrival information table 22, and determines what operation the NW aggregation device 13 should perform during that period.

Specifically, in a case where the NW aggregation device 13 is an OLT and the waiting time from when wireless data arrives at the ONU which is the NW aggregation device 13 until it is sent out is to be shortened, the control content determination unit 23 notifies the NW control unit 14 of allocation information (starttime, grant size) in the PON. Accordingly, the NW control unit 14 sends a grant to the NW terminal 12.

The control content determination unit 23 determines the control content so that, in a case where the NW aggregation device 13 is an optical distribution device and congestion is expected to occur in the NW host device 16, in order to avoid congestion, an output port of the uplink signal is switched to an output port to which another NW host device 16 is connected where congestion is not expected to occur. For example, the control content determination unit 23 determines the control content to connect a first port to which an uplink signal is input and a second port to which another NW host device 16 is connected where congestion is not expected to occur. Thus, the NW control unit 14 switches the connection between the ports of the NW aggregation device 13 according to an instruction from the control device 20.

As described above, in the present invention, the control device 20 does not control the NW aggregation device 13 on the basis of dynamic scheduling information received for each scheduling unit as in the conventional cooperative DBA, but rather controls the NW aggregation device 13 on the basis of allocation setting information that permits transmission from the user terminal 10 at a fixed period. Specifically, the base station master station 15 transmits allocation setting information that permits periodic transmission to the user terminal 10 via the base station slave station 11 by means of a configured grant used for scheduling in the mobile section. Therefore, the control device 20 acquires the setting information transmitted by the base station master station 15, and on the basis of the acquired setting information, determines control information for providing an instruction of the operation of the NW control unit 14 of the NW aggregation device 13 after a certain period of time. The control device 20 transmits the determined control information to the NW aggregation device 13.

In this way, in a case where allocation setting is performed by a configured grant, allocation information for the section between the user terminal 10 and the base station master station 15 is not included in the dynamic scheduling information (DCI), and therefore it is possible to avoid a situation in which “the actual amount of uplink transmission from the user terminal 10 is greater than expected (the amount calculated based only on the dynamic scheduling information)”. Furthermore, in conventional CTI-based cooperation, it was assumed that scheduling information would change dynamically, and it was necessary to reacquire the scheduling information every time. In contrast, in a case where a configured grant is used, it is considered that at least two slots are continuously and fixedly allocated, and therefore the determination can be made without waiting for the acquisition of information of the next allocation period. Furthermore, there is no need to acquire and process information for each allocation period. As a result, control information for a plurality of allocation periods can be determined by receiving the allocation setting information once, and thus the amount of processing can be reduced compared to the case where dynamic scheduling information is received each time. Hereinafter, a detailed description will be given on the basis of a specific system configuration in the case where the NW aggregation device 13 is an optical distribution device and in the case where the NW aggregation device 13 is an OLT.

### First Embodiment

In a first embodiment, a case will be described in which the NW aggregation device is an optical distribution device. In the first embodiment, congestion in a mobile backhaul is avoided by switching using an optical distribution device.

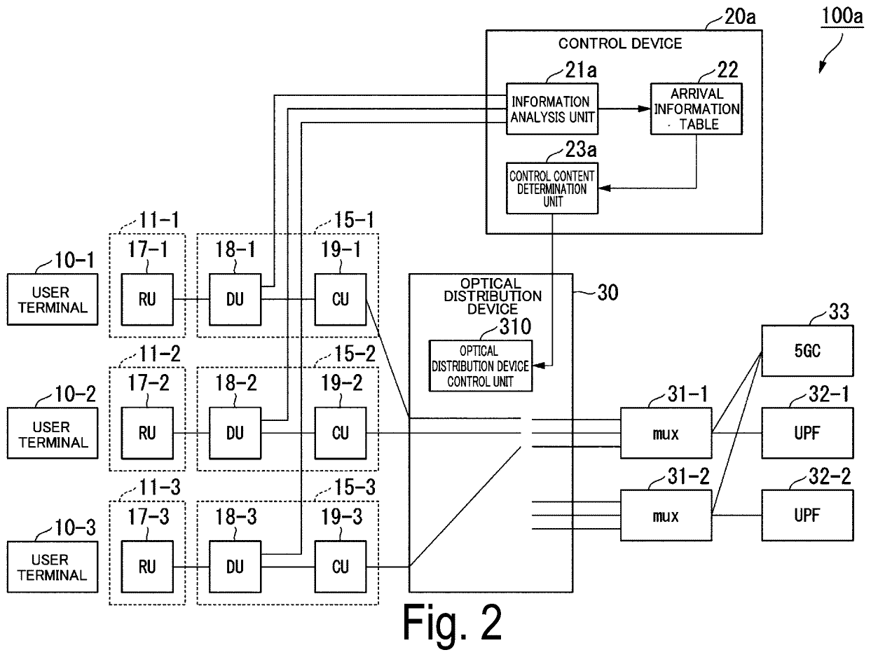

FIG. 2 is a diagram illustrating an example of a configuration of a wireless communication system 100a according to the first embodiment. The wireless communication system 100a includes a plurality of user terminals 10 (for example, user terminals 10-1 to 10-3), a plurality of RUs 17 (for example, RUs 17-1 to 17-3), a plurality of DUs 18 (for example, DUs 18-1 to 18-3), a plurality of CUs 19 (for example, CUs 19-1 to 19-3), a control device 20a, an optical distribution device 30, a plurality of muxes 31 (for example, muxes 31-1 to 31-2), a plurality of UPFs 32 (for example, UPFs 32-1 to 32-2), and a 5GC 33.

FIG. 2 illustrates a configuration in which the wireless communication system 100a includes three user terminals 10, three RUs 17, three DUs 18, and three CUs 19, and two muxes 31, and two UPFs 32, but the numbers of user terminals 10, RUs 17, DUs 18, CUs 19, muxes 31, and UPFs 32 are not particularly limited.

It is assumed that the user terminal 10-1 is wirelessly connected to the RU 17-1, the user terminal 10-2 is wirelessly connected to the RU 17-2, and the user terminal 10-3 is wirelessly connected to the RU 17-3. The RU 17-1 is connected to the DU 18-1 by wire, the RU 17-2 is connected to the DU 18-2 by wire, and the RU 17-3 is connected to the DU 18-3 by wire. The DU 18-1 is connected to the CU 19-1 and the control device 20a by wire, the DU 18-2 is connected to the CU 19-2 and the control device 20a by wire, and the DU 18-3 is connected to the CU 19-3 and the control device 20a by wire. Each of the CUS 19-1 to 19-3 is connected to the optical distribution device 30 by wire. The optical distribution device 30 is connected to the control device 20a and the muxes 31-1 to 31-2 by wire. The mux 31-1 is connected to the UPF 32-1 and the 5GC 33 by wire, and the mux 31-1 is connected to the UPF 32-2 and the 5GC 33 by wire.

The RU 17 corresponds to the base station slave station 11 illustrated in FIG. 1, and the DU 18 and CU 19 correspond to the base station master station 15 illustrated in FIG. 1. Here, the DU 18 notifies the control device 20a of the period of the configured grant for each user terminal 10 under its control.

The control device 20a includes an information analysis unit 21a, an arrival information table 22, and a control content determination unit 23a. The information analysis unit 21a calculates an arrival time of data within the control target period (n) of the optical distribution device 30 on the basis of the reference time of each user terminal 10 acquired from the dynamic scheduling information.

When the control content determination unit 23a detects that a traffic volume exceeding a congestion determination threshold value arrives at the beginning of a control target period of the optical distribution device 30, the control content determination unit 23a avoids the occurrence of congestion by switching the optical path from the CU 19 to which the user terminal 10 participating in the congestion is connected, to a different UPF 32 prior to the time. For example, the UPF 32a determines the control content to switch the optical path from the CU 19 to which the user terminal 10 participating in the congestion is connected, to a path connecting the UPF 32-1 to the UPF 32-2.

The optical distribution device 30 corresponds to the NW aggregation device 13 illustrated in FIG. 1. The optical distribution device 30 is, for example, an optical switch. The optical distribution device 30 may be any device other than an optical switch as long as it can switch the route of an optical path. The optical distribution device 30 has a plurality of first ports and a plurality of second ports, and outputs an optical signal input from one port to another port. The optical distribution device 30 includes an optical distribution device control unit 310.

The optical distribution device control unit 310 corresponds to the NW control unit 14. On the basis of the control content transmitted from the control device 20a, the optical distribution device control unit 310 controls the connection between the ports to connect the ports indicated by the control content.

The mux 31 is an optical multiplexer/demultiplexer that multiplexes or demultiplexes input optical signals. For example, the mux 31 multiplexes a plurality of optical signals output from the optical distribution device 30 and outputs the multiplexed optical signals to the UPF 32 and the 5GC 33. For example, the mux 31 demultiplexes an optical signal output from the UPF 32 or the 5GC 33 and outputs the demultiplexed optical signal to the optical distribution device 30.

The UPF 32 is a user-plane node in the 5G core network. The UPF 32 is a relay device that performs processing for transmitting and receiving user data. For example, the UPF 32 performs processing for transmitting and receiving user data between an external network and the base station master station 15.

The 5GC 33 is a core network device in 5G. The 5GC 33 notifies each user terminal 10 of the periodic allocation using a radio resource control (RRC) message. For example, when a user of the user terminal 10-1 enters into a contract with a network operator and a configured grant, which is a periodic allocation for the user terminal 10-1, is set in the 5GC 33, the 5GC 33 transmits, to the user terminal 10-1, a message indicating that a configured grant will be made at a predetermined period (250 us period).

Here, the process flow of the wireless communication system 100a will be described. It is assumed that the 5GC 33 notifies the user terminal 10-1, the user terminal 10-2, and the user terminal 10-3 by an RRC message that semi-persistent scheduling is performed at a 250 us period, a 500 us period, and a 1 ms period, and that each user terminal 10 and each DU 18 holds this information. Each DU 18 notifies the control device 20a of information on the period of the configured grant for each user terminal 10 under its control. This allows the control device 20a to acquire the scheduling information. The amount of data transmitted each time can be ascertained on the basis of a modulation and coding scheme (MCS) and a transport block size (TBS) included in the RRC message.

A main signal in an uplink direction is transmitted from each user terminal 10 to the UPF 32 via the RU 17, the DU 18, the CU 19, the optical distribution device 30, and the mux 31. The UPF 32 and higher are connected to an external internet protocol (IP) network, for example, an edge data center or the Internet.

In the first embodiment, the DU 18 determines the scheduling for the wireless section of the user terminal 10 under its control. The DU 18-1, which is equipped with a scheduler for the user terminal 10-1, holds information about the configured grant for the user terminal 10-1 (at least the period given in the configured grant and information corresponding to the reference time (for example, subframe number and slot number)) so that the configured grant set for the user terminal 10-1 does not overlap (in time or frequency) with transmission permissions for other user terminals 10 under the control of RU 17-1.

The DU 18-1 can notify the user terminal 10-1 of the timing for starting the configured grant (periodic transmission) by means of a DCI message. For example, in a case where there is a user terminal 10 for which a configured grant has already been set under the same RU 17, the DU 18-1 allocates time and frequency to the user terminal 10 so that it does not overlap with the user terminal 10-1 for which a new configured grant is being set. The DU 18-1 notifies the control device 20a of information related to this configured grant. The same is true for the DUs 18-2 and 18-3.

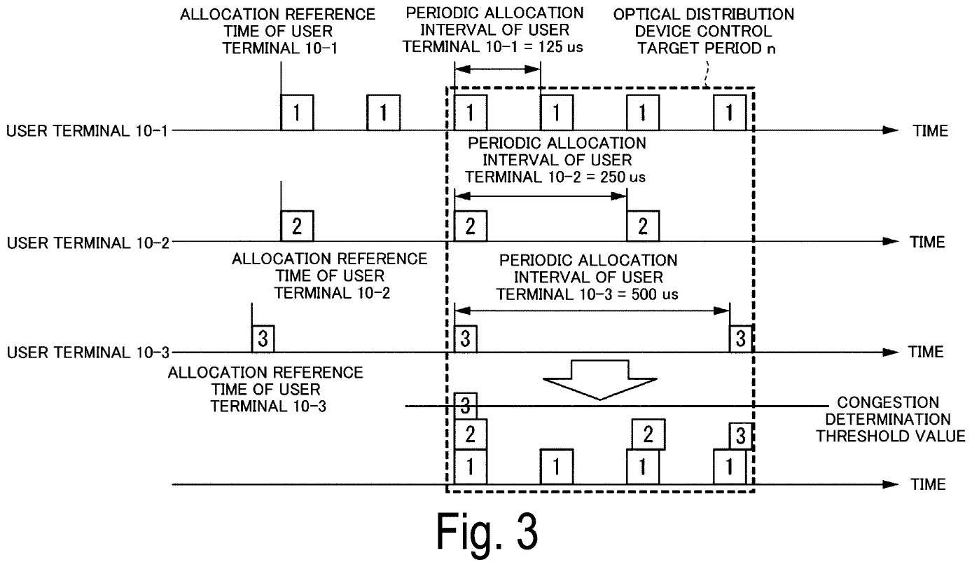

FIG. 3 is a diagram for describing an overview of a process performed by the control device 20a according to the first embodiment. The information analysis unit 21a of the control device 20a calculates, on the basis of the received RRC information for each user terminal 10, what time the upstream traffic will arrive at the CU 19, as illustrated in FIG. 3. For example, the information analysis unit 21a calculates the sum of the upstream traffic arriving at the CU 19 at the overlapping times. As illustrated in FIG. 3, if the sum of the traffic from the user terminal 10-1 arriving at the CU 19-1, the traffic from the user terminal 10-2 arriving at the CU 19-2, and the traffic from the user terminal 10-3 arriving at the CU 19-3 exceeds a link rate between the mux 31 and the UPF 32-1 (illustrated as the congestion determination threshold value in FIG. 3), packet loss or queuing delay will occur in the section between the mux 31 and the UPF 32-1. The congestion determination threshold value is a threshold value for determining whether or not the link rate between the mux 31 and the UPF 32 has been exceeded. The congestion determination threshold value is determined in advance.

Therefore, the control content determination unit 23a determines the control content so that the traffic from the user terminal 10-3 arriving at the CU 19-3 is directed to the UPF 32-2. In this case, the control content determination unit 23a determines the control content to connect the first port of the optical distribution device 30 to which the CU 19-3 is connected and the second port of the optical distribution device 30 to which the UPF 32-2 is connected. The control content determination unit 23a transmits the determined control content to the optical distribution device 30.

The control content determination unit 23a may ascertain the time required to switch the optical distribution device 30 so that traffic heading from the CU 19-3 to the optical distribution device 30 is not lost due to the switching, and may designate the timing to instruct the switching of the optical distribution device 30 to be completed before traffic from the CU 19-3 arrives for the optical distribution device 30.

When the control content determination unit 23a detects that the total traffic transmitted from the CU 19 exceeds the congestion determination threshold value for the UPF 32-1, the control content determination unit 23a selects a CU 19 such that switching the transmission destination to the UPF 32-2 will not exceed the congestion determination threshold value of the UPF 32-2, and performs the switching. This prevents new congestion from occurring due to the switching. The control device 20a only needs to perform the above-mentioned switching determination all at once for the control target period of the optical distribution device 30, which is set to 500 us in FIG. 3.

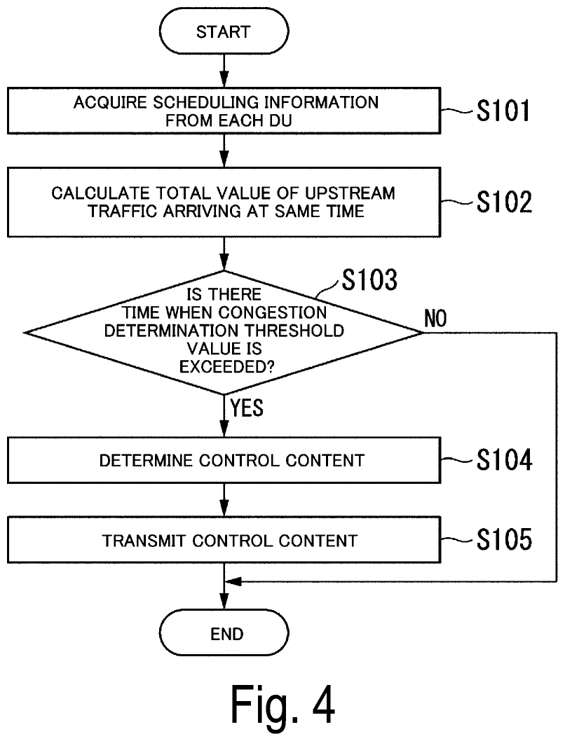

FIG. 4 is a flowchart showing a process flow of the control device 20a according to the first embodiment.

The information analysis unit 21a acquires the scheduling information transmitted from each DU 18 (step S101). The information analysis unit 21a calculates the sum of upstream traffic arriving at the CU 19 at the same time, on the basis of the received scheduling information for each user terminal 10 (step S102). The information analysis unit 21a registers the calculated time of arrival at the CU 19 in the arrival information table 22 in association with the sum of traffic at that time.

The control content determination unit 23a determines whether or not there is a time when a congestion determination threshold value is exceeded on the basis of the information registered in the arrival information table 22 (step S103). In a case where the control content determination unit 23a determines that there is no time when the congestion determination threshold value is exceeded (step S103—NO), the control content determination unit 23a ends the process of FIG. 4.

On the other hand, in a case where the control content determination unit 23a determines that there is a time when the congestion determination threshold value is exceeded (step S103—YES), the control content determination unit 23a determines the control content (step S103). Specifically, the control content determination unit 23a determines the control content for controlling the optical distribution device 30 so that congestion does not occur at the time when the congestion determination threshold value is exceeded.

As an example, as described with reference to FIG. 3, the control content includes switching the route of the optical path of the optical distribution device 30 so that part of the traffic at the time when the congestion determination threshold value is exceeded flows to another path. Note that this control content is merely an example, and other control content may be used as long as it is for controlling the optical distribution device 30 so that congestion does not occur at the time when the congestion determination threshold value is exceeded. The control content determination unit 23a transmits the determined control content to the optical distribution device 30.

Thus, the route of the optical path is switched in the optical distribution device control unit 310 of the optical distribution device 30, so that the occurrence of congestion can be avoided.

According to the wireless communication system 100a configured as described above, the DU 18 acquires allocation setting information that permits periodic transmission of the user terminal 10 under its control on the basis of the RRC message transmitted from the 5GC 33. Each DU 18 notifies the control device 20a of the acquired allocation setting information that permits periodic transmission. The control device 20a determines the control content of the optical distribution device 30 on the basis of the allocation setting information that permits periodic transmission transmitted from each DU 18. In a case where a configured grant is used, it is considered that at least two slots are continuously and fixedly allocated, and therefore the determination can be made without waiting for the acquisition of information of the next allocation period. Accordingly, there is no need to acquire and process information for each allocation period. As a result, control information for a plurality of allocation periods can be determined by receiving the allocation setting information once. In this way, since it is not necessary to receive scheduling information on a slot-by-slot basis, it is possible to reduce the processing load on the control device 20a.

As described above, even in a case where short-period scheduling intervals including the shortest period of 125 us are allocated, according to the present invention, the control period of the control device 20a is 1 ms, and control can be performed at periods longer than that interval.

### Second Embodiment

In a second embodiment, a case will be described in which the NW aggregation device is an OLT in a PON. In the first embodiment, when accommodating a fronthaul in a PON, the uplink transmission waiting time in an ONU is reduced.

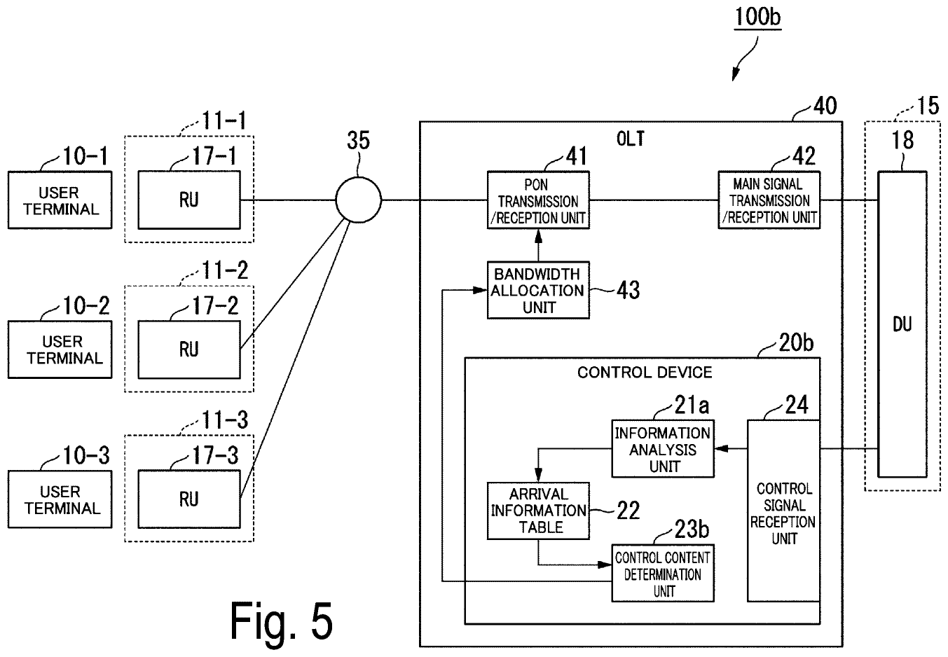

FIG. 5 is a diagram illustrating an example of a configuration of a wireless communication system 100b according to the second embodiment. The wireless communication system 100b includes a plurality of user terminals 10 (for example, user terminals 10-1 to 10-3), a plurality of RUs 17 (for example, RUs 17-1 to 17-3), a splitter 35, an OLT 40, and a DU 18. FIG. 5 illustrates a configuration in which the wireless communication system 100b includes three user terminals 10 and three RUs 17, but the numbers of user terminals 10 and RUs 17 are not particularly limited.

It is assumed that the user terminal 10-1 is wirelessly connected to the RU 17-1, the user terminal 10-2 is wirelessly connected to the RU 17-2, and the user terminal 10-3 is wirelessly connected to the RU 17-3. The RUs 17-1 to 17-3 are connected to the splitter 35 by wire. The splitter 35 is connected to the OLT 40 by wire. The OLT 40 is connected to the DU 18 by wire.

The RU 17 corresponds to the base station slave station 11 illustrated in FIG. 1, and the DU 18 corresponds to the base station master station 15 illustrated in FIG. 1. Here, the DU 18 notifies a control device 20b of the period of the configured grant for each user terminal 10 under its control. The contents of the notification are the same as those in the second embodiment.

The splitter 35 multiplexes or splits the input optical signal and outputs it. For example, the splitter 35 multiplexes the optical signals transmitted from each RU 17 and outputs the multiplexed optical signals to the OLT 40. For example, the splitter 35 splits an optical signal transmitted from the OLT 40 and outputs the split optical signal.

The OLT 40 includes a control device 20b, a PON transmission/reception unit 41, a main signal transmission/reception unit 42, and a bandwidth allocation unit 43. The control device 20b includes an information analysis unit 21a, an arrival information table 22, a control content determination unit 23b, and a control signal reception unit 24. The control device 20b is different in configuration from the control device 20a in that it includes a control content determination unit 23b instead of the control content determination unit 23a, and in that it newly includes a control signal reception unit 24. The other configuration of the control device 20b is similar to that of the control device 20a. The differences from the control device 20a will be described below.

The control signal reception unit 24 receives information on the period of the configured grant transmitted from the DU 18 for each user terminal 10 under the control of the DU 18.

On the basis of the information registered in the arrival information table 22, the control content determination unit 23b calculates the amount and time to be transmitted from the ONUs connected to each RU 17 during the OLT control target period. The control content determination unit 23b determines the control content to allocate a bandwidth to each ONU on the basis of the calculation result.

The PON transmission/reception unit 41 transmits and receives optical signals in a PON section (for example, a section between the RU 17 and the OLT 40).

The main signal transmission/reception unit 42 transmits and receives a main signal. For example, the main signal transmission/reception unit 42 transmits a main signal transmitted from the user terminal 10 to the DU 18, and transmits a main signal transmitted from the DU 18 to the PON section via the PON transmission/reception unit 41.

The bandwidth allocation unit 43 allocates bandwidth to each ONU on the basis of the control content determined by the control content determination unit 23b.

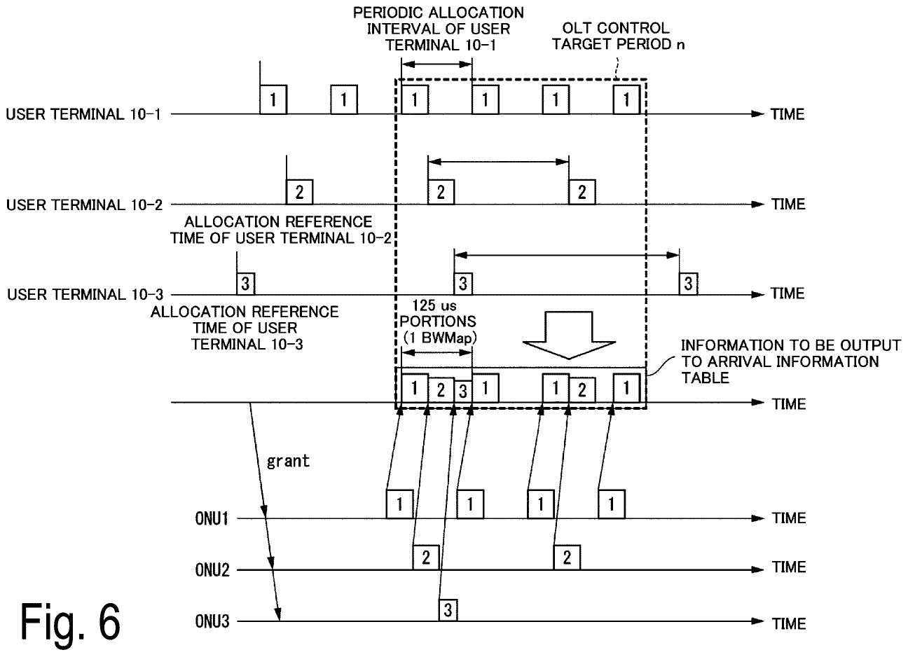

FIG. 6 is a diagram for describing an overview of a process performed by the control device 20b according to the second embodiment. The control content determination unit 23b calculates the amount and time to be transmitted from the ONUs connected to each RU 17 during the OLT control target period. The control content determination unit 23b determines the control content to allocate a bandwidth to each ONU on the basis of the calculation result. For example, the control content determination unit 23b determines the control content so that a bandwidth is allocated to each ONU prior to the time when traffic from the RU 17 arrives at the ONU. In the second embodiment, the OLT control target period is set to 500 us, and the configured grant is received sufficiently before the OLT control target period. The bandwidth allocation information (BWMap) described in ITU-T G.989.3 is transmitted at a period of 125 us, but it is sufficient that the actual allocation calculation is performed on the basis of the information in the configured grant and is output in 125 us portions from the information registered in the arrival information table 22.

According to the wireless communication system 100b configured as above, the control device 20b acquires allocation setting information transmitted from the DU 18 that permits periodic transmission from the user terminals 10 under its control. The control device 20b determines the control content regarding the bandwidth allocation on the basis of the allocation setting information that permits periodic transmission transmitted from the DU 18. In a case where a configured grant is used, it is considered that at least two slots are continuously and fixedly allocated, and therefore the determination can be made without waiting for the acquisition of information of the next allocation period. Accordingly, there is no need to acquire and process information for each allocation period. As a result, control information for a plurality of allocation periods can be determined by receiving the allocation setting information once. In this way, since it is not necessary to receive scheduling information on a slot-by-slot basis, it is possible to reduce the processing load on the control device 20a.

As described above, even in a case where short-period scheduling intervals including the shortest period of 125 us are allocated, according to the present invention, the control period of the control device 20b is 1 ms, and control can be performed at periods longer than that interval.

The above-mentioned control devices 20, 20a, and 20b may be implemented by a computer. In such a case, a program for implementing the functions may be recorded in a computer-readable recording medium, and the functions may be implemented by loading the program recorded on this recording medium to a computer system, and executing the program. Note that the “computer system” mentioned herein includes an OS and hardware such as peripheral devices. In addition, the “computer-readable recording medium” refers to a portable medium such as a flexible disk, a magneto-optical disk, a ROM, or a CD-ROM or a storage device such as a hard disk that is built into the computer system.

Further, the “computer-readable recording medium” may include a medium that dynamically holds the program for a short time, such as a communication line in a case where the program is transmitted via a network such as the Internet or a communication line such as a telephone line, and a medium that holds the program for a certain period of time, such as a volatile memory inside a computer system serving as a server or a client in that case. Also, the foregoing program may be for implementing some of the functions described above, may be implemented in a combination of the functions described above and a program already recorded in a computer system, or may be implemented with a programmable logic device such as a field programmable gate array (FPGA).

Although the embodiments of the present invention have been described in detail with reference to the drawings, specific configurations are not limited to the embodiments, and include design and the like within the scope of the present invention without departing from the gist of the present invention.

### Industrial Applicability

The present invention can be applied to techniques relating to scheduling of uplink communications such as a mobile system fronthaul.

### REFERENCE SIGNS LIST

10, 10-1 to 10-3 User terminal
11, 11-1 to 11-3 Base station slave station
12, 12-1 to 12-3 NW terminal
13 NW aggregation device
14 NW control unit
15 Base station master station
16 NW host device
17, 17-1 to 17-3 RU
18, 18-1 to 18-3 DU
19, 19-1 to 19-3 CU
20, 20a, 20b Control device
21, 21a Information analysis unit
22 Arrival Information Table
23, 23a, 23b Control content determination unit
30 Optical distribution device
31, 31-1 to 31-2
32, 32-1 to 32-2 UPF
33 5GC
100, 100a, 100b Wireless communication system

1. A control device connected to a master station device via a network in a mobile communication system in which the master station device is connected to a user terminal via a slave station device, the control device comprising:
an information analyzer configured to acquire information on a control message that is transmitted from the master station device to the user terminal connected to the slave station device and that grants periodic transmission permission, and calculate, on the basis of the acquired control message, a time at which upstream traffic from the user terminal will arrive at a network device that is provided between the master station device and a host device or that includes an own device, during a control target period that is longer than the shortest period of the periodic transmission permission; and
a control content determiner configured to determine control content for controlling an operation of the network device on the basis of the calculated time and transmit the determined control content to the network device.

2. The control device according to claim 1, further comprising an arrival information storage in which at least information on the time calculated by the information analyzer is registered,
wherein the information analyzer updates the information registered in the arrival information storage unit when the periodic transmission permission is updated.

3. The control device according to claim 1,
wherein the network device is an optical distribution device that switches output destinations, and
the control content determiner determines control content for controlling the output destinations of the optical distribution device.

4. The control device according to claim 1,
wherein the network device is a master station device of a time division multiplexing system that performs dynamic bandwidth allocation, and
the control content determiner determines control content for designating bandwidth allocation for the master station device.

5. A control method performed by a control device connected to a master station device via a network in a mobile communication system in which the master station device is connected to a user terminal via a slave station device, the control method comprising:
acquiring information on a control message that is transmitted from the master station device to the user terminal connected to the slave station device and that grants periodic transmission permission;
calculating, on the basis of the acquired control message, a time at which upstream traffic from the user terminal will arrive at a network device that is provided between the master station device and a host device or that includes an own device, during a control target period that is longer than the shortest period of the periodic transmission permission;
determining control content for controlling an operation of the network device on the basis of the calculated time; and
transmitting the determined control content to the network device.
